(19) United States
(12) Patent Application Publication
(10) Pub. No.: US 2004/0247801 A1
(43) Pub. Date: Dec. 9, 2004

(54) Solid surface products

(76) Inventor: Dennis Schober, Renton, WA (US)

Correspondence Address: BLACK LOWE & GRAHAM, PLLC, 701 FIFTH AVENUE, SUITE 4800, SEATTLE, WA, 98104, US

(21) Appl. No.: 10/794,172

(22) Filed: Mar. 5, 2004

Related U.S. Application Data
(63) Continuation-in-part of application No. 10/106,833, filed on Mar. 25, 2002, now Pat. No. 6,743,327.
(60) Provisional application No. 60/307,898, filed on Jul. 25, 2001.

(51) Int. Cl. B44F 1/00

(52) U.S. Cl. 428/13; 156/286; 156/311

(57) ABSTRACT

A flat non-porous unitary solid surface structure is formed. A texture is imparted to a first flat non-porous unitary thermoplastic polymeric sheet having first and second planar aspects, the texture is imparted to the first planar aspect. A decorative material is arranged on the first planar aspect. A second flat non-porous unitary thermoplastic polymeric sheet is placed in contact with the decorative material in opposition with the first planar aspect; whereby a lay-up sandwich is formed. A predetermined amount of heat and pressure is applied by contact with cauls of a press to the lay-up sandwich for a predetermined period of time. Opening the press allows air and gases to escape from the lay-up sandwich. The press is closed and is applying a predetermined amount of heat and pressure to the lay-up sandwich for a predetermined period of time whereby the first and second polymeric material sheets melt together.

### CROSS-REFERENCE TO RELATED APPLICATION

This application claims priority as a continuation in part of U.S. patent application Ser. No. 10/106,833, filed Mar. 25, 2002 and entitled Solid Surface Products, itself claims priority from U.S. Provisional Application No. 60/307,898 filed Jul. 25, 2001. Each of the Utility Patent application and Provisional Patent application is incorporated by the references above.

### FIELD OF THE INVENTION

The present invention relates to flat non-porous unitary solid surface structures, and more particularly, to flat non-porous laminated solid surface products.

### BACKGROUND OF THE INVENTION

Prior to the present invention, there existed a long-felt need for a dry process for making a unitary solid surface product comprised of: (1) a laminate made of thermoplastic laminate layers; and (2) one or more visible decorative objects (objects that are visible to the unaided human eye) that are permanently fixated between or incorporated in laminate layers. It was believed by knowledgeable people in the plastics industry that it was not possible to make such a solid surface product without using a mold and casting therein a liquid resin around the object to be fixated. It is believed that researchers who attempted to make such products using a dry process (that is, a process without using a mold and casting a liquid resin around the object to be fixated) produced products which contained defects such as air bubbles entrapped in the laminate, voids in the laminate, or cracks in the laminate.

Attempts to incorporate decorative materials into laminate layers of a solid surface product resulted in the fixation of gas bubbles along with the decorative obscuring the object to be fixated in the laminate resulting in a display that fails to be as decorative as the objects without the gas bubbles. Mating surfaces on the layers of thermoplastic can readily trap such gas bubbles, the smooth surfaces being well suited to seal such bubbles in the course of lamination. Variations of temperature and pressure have proven insufficient for the elimination of the gas bubbles.

There is an unmet need in the art for a method, and a solid surface produced by the method, for embedding decorative objects within a laminated solid surface.

### SUMMARY OF THE INVENTION

A flat non-porous unitary solid surface structure is formed. A texture is imparted to a first flat non-porous unitary thermoplastic polymeric sheet having first and second planar aspects, the texture is imparted to the first planar aspect. A decorative material is arranged on the first planar aspect. A second flat non-porous unitary thermoplastic polymeric sheet is placed in contact with the decorative material in opposition with the first planar aspect; whereby a lay-up sandwich is formed. A predetermined amount of heat and pressure is applied by contact with cauls of a press to the lay-up sandwich for a predetermined period. Opening the press allows air and gases to escape from the lay-up sandwich. The press is closed and is applying a predetermined amount of heat and pressure to the lay-up sandwich for a predetermined period of time whereby the first and second polymeric material sheets melt together.

As was set forth in the parent application, the typical laminate construction within this invention includes:

a thermoplastic or glass top sheet with at least one planar aspect, the planar aspect being textured;

single or multiple layers of decorative materials; and

a thermoplastic or glass bottom sheet.

### BRIEF DESCRIPTION OF THE DRAWINGS

A flat non-porous unitary solid surface structure is formed. A texture is imparted to a non-porous unitary thermoplastic polymeric sheet having first and second planar aspects; the texture is imparted to the first planar aspect. A decorative material is arranged on the first planar aspect. A second flat non-porous unitary thermoplastic polymeric sheet is placed in contact with the decorative material in opposition with the first planar aspect; whereby a lay-up sandwich is formed. A predetermined amount of heat and pressure is applied by contact with cauls of a press to the lay-up sandwich for a predetermined period of time. Opening the press allows air and gases to escape from the lay-up sandwich. The press is closed and is applies a predetermined amount of heat and pressure to the lay-up sandwich for a predetermined period of time whereby the first and second polymeric material sheets melt together.

FIG. 1 is a pictorial or three-dimensional view of one embodiment of the invention illustrating a unitary solid surface product having a layer of decorative objects that are permanently fixated in the laminate;

FIG. 2 is a vertical cross-sectional view of the product of FIG. 1 when viewed in the direction of the arrows in FIG. 1 (The phantom line in FIG. 2 indicates the location where the inner surfaces of two sheets of polymeric material interfaced before they melted together in the manufacturing process);

FIG. 3 is an exploded pictorial view illustrating the thermoplastic sheets that have been textured on both surfaces, along with an arranged layer of decorative objects.

### DETAILED DESCRIPTION OF THE PREFERRED EMBODIMENT

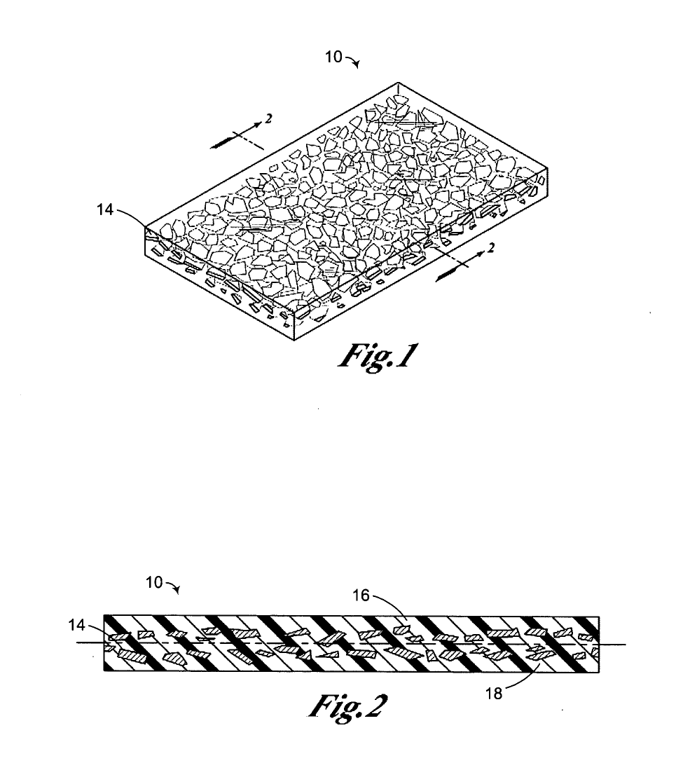

FIG. 1 is a pictorial or three-dimensional view of one embodiment of the invention illustrating a unitary solid surface product having a layer of decorative objects that are permanently fixated in the laminate. The present invention provides non-porous unitary solid surface products and methods for manufacturing the same.

By the term “unitary,” it is meant that the products is a physically an undivided single piece, and therefore not a laminate structure consisting of separate layers that can be separated or delaminated. It should be understood that some products of the invention might visually appear (to the unaided human eye) to be a laminate of separate layers that maintain their integrity, but this visual appearance is not correct.

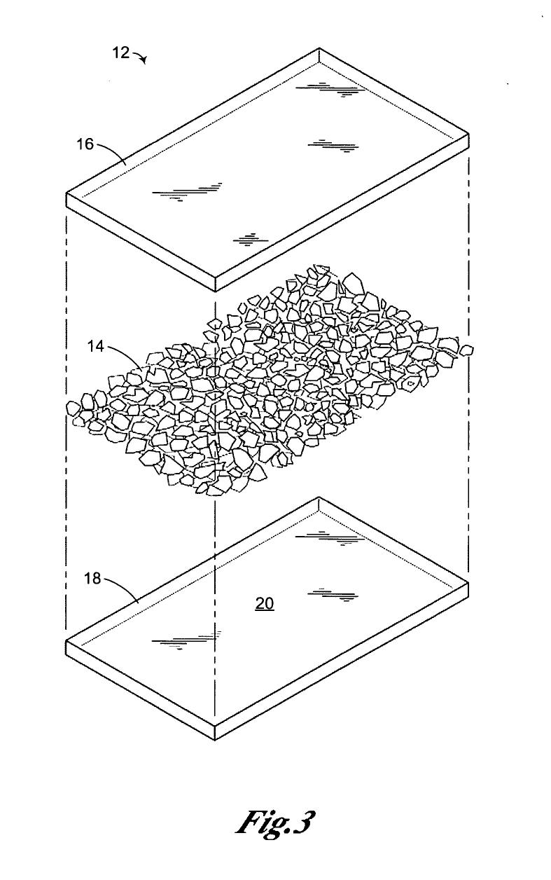

Referring to FIGS. 1 and 2, the layers of polymeric starting material have in fact melted together and have become an undivided single piece. The unitary solid surface laminate 10 constructed according to the presently preferred embodiment of the invention contain fixated decorative objects 14. The decorative objects 14 can be made of various materials as will be described below. Variations on this basic lay-up sandwich or laminate 12 may include more than two layers of thermoplastic polymeric sheet and multiple layers of decorative materials, alternating one and then the other. For example, the basic lay-up sandwich or laminate 12 may consist of:

a top sheet of polymeric material;

a first layer of decorative material;

an intermediate sheet of polymeric material;

a second layer of a decorative material; and

a bottom sheet of polymeric material.

The thickness of laminate 10 may range from about 0.030 inch (0.7937 mm) to 2.0 inches (50.80 mm). However, thicker and thinner gauges are possible based on the press capabilities and polymeric material used.

From the standpoint of aesthetically-pleasing visual appearance, line drawings and words are not capable of describing the strikingly beautiful and unusual visual effects provided by the solid surface products of the invention. The inventive solid surface products may be employed to make countertops, sinks, lavatories, desktops, table tops, chairs, windowsill, and the like.

### The Basic Lay-Up Sandwich

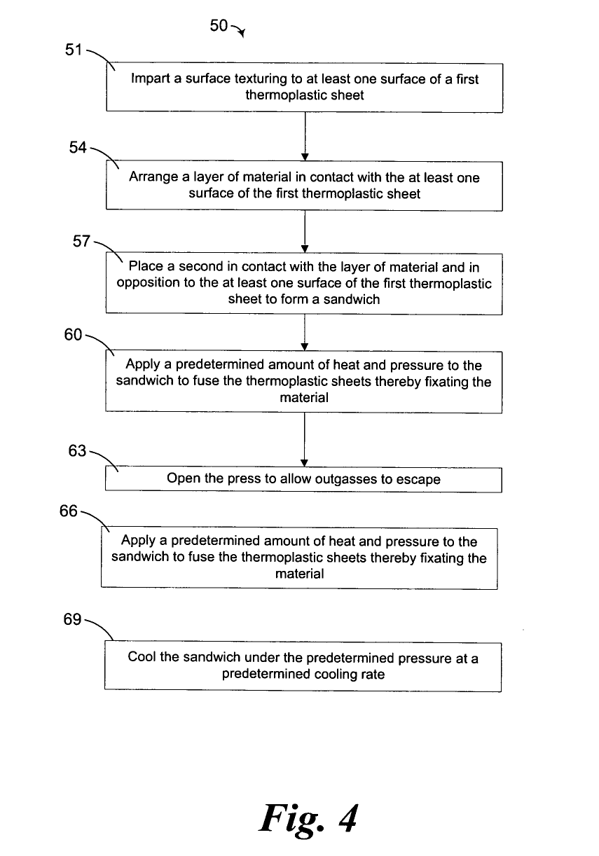

Referring to FIG. 3, the unitary solid surface 10 of this invention is made from a basic lay-up sandwich 12 including the following starting materials:

a bottom sheet 18 made of thermoplastic polymeric material;

one or more layers of a decorative material 14 (the object to be fixated) which also functions as a breather layer for air and gases to escape during the manufacturing process; and,

a top sheet made of thermoplastic polymeric material 16.

In the presently preferred embodiment of the invention, one or both surfaces 20 of the thermoplastic sheets 16, 18 are textured to degrade the smoothness of mating surfaces 20 that will embrace the fixated decorative material 14 thereby providing an escape path for air, water vapor, and gases generated during the pressing operation.

### Materials 14 for Decorative Object to be Fixated

The material 14 to be fixated in the polymeric sandwich 12 may be made of glass shards, stones, pebbles, metallic parts, textile fabric, paper, plastic film, plastic sheet, mesh, bar, wood veneer, and various dried natural materials. It is important the material be dry to minimize the generation of water vapor or steam during the manufacturing process.

As mentioned above, the material 14 to be fixated in the sandwich 12 may also be made of wood veneer, paper, dried plant fibers and parts. Non-limiting examples are: cellulose, cotton, linen, pulp, rag, dried plant materials and fibers including long-stem grass, leaves, petals, bark and twigs from reed, bamboo, papyrus, banana, mulberry, and wicker. For these types of material, the thickness of the layer may be from about 0.00045 inch (0.0114 mm) to 0.25 inch (6.35 mm).

The material 14 to be fixated in the polymeric sandwich 12 may also be made of dry metal. Non-limiting examples are: copper, bronze, brass, steel, stainless steel, iron, nickel, and aluminum the material 14 may be any of a variety of shapes including: rod, mesh, sheet, perforated sheet, foil, strips, shavings, woven, and cable. Additionally, metal parts such as gears, worms, impellers, and similar discrete parts may also be material 14 fixated in the polymeric sandwich 12. The metal may be decorated such as etched, anodized, sanded, brushed, stained, painted, printed, chemically treated, galvanized, corroded, aged, polished, and plated. For these types of material, the thickness of the layer for optimal incorporation and fixation is from about 0.00045 inch (0.0114 mm) to 1.0 inch (25.4 mm) while thinner and thicker layers are possible.

The sole issue in the viability of the fixation process is the volume of the gas to be displaced in the course of the fusion of sandwich 12 into the laminate 10. That volume is determined by the size of the material 14, and heating the sandwich 12 generates a volume of such additional gas due to the volatility of incorporated substances in the material 14. Texturing imparted onto the mating surface 20 of first polymeric layer 16 and optionally, the second polymeric layer is configured to permit the displacement of that volume out of the laminate 10 in the course of fusion.

### Thermoplastic Polymeric Materials

Thermoplastic Polymeric materials constituting the non-porous polymeric sheets 16 and 18 may be made up of any of a number of suitable thermoplastic materials. Among the typical materials are Acrylic e.g. (polymethyl metacrylate PHMA), Polycarbonate, PVC e.g. (polyvinyl chloride), Polyethylene (HDPE, LDPE), Polypropylene, Polyester, Nylon and Polyurethane, Polystyrene, Fluoropolymers, ABS (Acrylonitrile-Butadiene-Styrene). Thermoplastic materials can be cast, extruded, calendared, blown, injection molded, or formed by other means common to the plastics industry. Materials can include variations such as color texture, frost, translucent, opaque, fire retardant, and performance additives. Materials can be blended to create combination plastics, such as CPVC, ABS/Polycarbonate, ABS/PVC, Polycarbonate/Acrylic, PVC/Acrylic, etc.

The non-porous polymeric sheets 16 and 18 may be clear (transparent), colored, textured (on one or both faces), frosted, translucent, opaque, and they may also contain fire-retardant additives and performance additives. The polymeric thermoplastic sheets 16 and 18 may optimally vary in thickness from about 0.004 inch (0.100 mm) to 1.0 inch (25.4 mm), though thicker and thinner sheets may also be fused into the sandwich or laminate 12. Also, the polymeric sheets 16 and 18 in the basic lay-up sandwich or laminate 12 may vary in thickness from each other.

The thermoplastic material is generally manufactured either by casting or by extrusion. The presently preferred thermoplastic sheet material is made by extrusion and has more consistent gauge. Thermoplastic sheet material made by casting has inconsistent gauge (hills and valleys) that will cause problems with air and gas entrapment and also inhibits the imparting of gloss or texture on the outer surface of the product caused by pressure variations in the fusion process.

In the presently preferred embodiment, the material 14 is assessed to determine a likely volume of gas that will outgas in the manufacturing process and thereby determine the appropriate degree of texturing for the mating surfaces 20 to allow the appropriate escape of the outgases to the ambient atmosphere. The assessment process may, in one presently preferred embodiment, be by trial fusions. Another is by predictive volumetric calculations.

### Manufacturing Processes

The invention also includes methods for manufacturing the unitary solid surface laminate 10. These manufacturing methods do not involve using a mold and casting a liquid resin around the object to be fixed.

Referring to FIG. 4, in order to produce laminates 12 which are free of defects (such as air or gas bubbles entrapped in the sandwich 12, voids in the laminate 10, or cracks in the laminate 10) when pressing the above-described basic lay-up, one presently preferred embodiment includes a method 50. The laminates 10 are made by positioning or “laying-up” thermoplastic or glass sheets, and decorative materials in the correct sequence to create a “sandwich” 12 and then applying heat and pressure to fuse the materials together creating a single sheet. If the top or bottom layers of the sandwich 12 are thermoplastic, during the lamination process they can be textured or embossed using a variety of texture media including texture papers, fabrics, release films, molds, texture plates (composite or metal), silicone blankets, foam sheets, and other texture media known to those with ordinary skill in the art. Textured, frosted, etched or sandblasted glass sheets can also be used as the top or bottom layer of the laminate to create a similar textured effect.

At a block 51, a texture is imparted on to a sheet of thermoplastic. Generally, textures are imparted for their decorative effect; for instance, where a thermoplastic is laminated onto a paper bearing a wood grain pattern, a wood pore texture release paper is selected to give authenticity to the final product. A variety of suitable texture papers are available from S.D. Warren, Westbrook, Me., and release films (polyester, polyvinyl fluoride and perfluoroalkoxy tetraflouroethylene) are available from DuPont, Buffalo, N.Y. The papers and films have specific textures and gloss levels that are transferred into the thermoplastic sheet laminate when the laminate is at the optimal heat and pressure and prevent the plastic sheet from sticking to the caul plate. Under heat and pressure, the thermoplastic sheet will flow and conform to the texture provided.

Once cured, the laminate is removed, or released in the case of release paper. Release paper has several advantages over plates and metal bands, and because it can be reused in continuous thin laminate or continuous board processing, release paper is also a cost saving alternative. While imparting a texture with release paper will work, so too, will any of the methods known in the art for imparting a texture.

As indicated above, the reason for imparting texture is to degrade the mating surfaces 20, of at least one of the first thermoplastic sheet 16 and the second thermoplastic sheet 18. The degrading of the mating surfaces allows outgassing along the mating surfaces in the course of laying up the sandwich 12 before the fusion of the thermoplastic sheets 16, 18. Rather than the smooth surfaces coming in contact under pressure and temperature to immediately fuse, the texture provides passages to the ambient atmosphere allowing outgassing.

At a block 54, the decorative materials 14 are arranged in contact with the at least one textured mating surface 20. The decorative materials 14 are arranged in a generally uniform consistency across the textured mating surface 20 in order to achieve a pleasing effect. Advantageously, arrangement in a generally uniform consistency provides for uniform dispersal of the gasses.

At a block 57, a second layer of thermoplastic polymeric sheeting 18 is placed in contact with the decorative material 14 in opposed relation to the first thermoplastic polymeric sheeting 16.

At a block 60, the basic lay-up sandwich 12 is processed in a heated press that can apply the required heat and pressure to melt the polymeric sheets 16 and 18 together and thereby create the sandwich 12 that fixates the one or more decorative objects 14 within the laminate. Most preferred is a steam-heated multiple opening press or MOP.

A typical thermoplastic sandwich 12 “lay-up” construction along with the generally used parts of the press such as the presently preferred embodiment is:

Top

Padding

Caul plate

Texture/release paper or films

Thermoplastic sheet

Decorative material

Thermoplastic sheet

Texture/release paper or films

Caul plate

Padding

Loader pan

Bottom

When using the preferred polymeric sheets described above, the press should be preheated to a temperature of about 280° F. Then the lay-up sandwich is loaded into the press. The press is then closed against the lay-up sandwich at a pressure of about 40 pounds per square inch (psi). The press temperature is then ramped up until the lay-up sandwich reaches a temperature of about 290° F.-310° F. while maintaining the pressure at about 40 psi. This temperature works well for polymethylmethacrylate and polyvinyl chloride. Polycarbonate requires a higher temperature of about 350° F.-375° F.

At a block 63, this point the press is opened to vent the outgasses and all pressure is removed from the lay-up sandwich. This step is referred to as “bumping” the press. This step is included to allow the heated air, water vapor, and gases to escape from between the polymeric sheets 16 and 18 in the lay-up sandwich so that bubbles or voids are not entrapped in the sandwich 12.

At a block 66, the press is then closed against the lay-up sandwich and the pressure, again, is ramped up to the predetermined pressure, generally about 160 psi. The press temperature is then ramped up until the materials in the lay-up sandwich reach a temperature suitable to fuse the thermoplastic polymeric sheets 16 and 18 together, generally about 290° F.-310° F. while maintaining the pressure at about 160 psi. The temperatures recited are used where the thermoplastic sheets are polymethylmethacrylate and polyvinyl chloride, but polycarbonate requires a higher temperature of 350° F.-375° F. The pressure and temperature is, then, held for about 1 to 6 minutes depending on the thickness of the lay-up sandwich to allow the polymeric sheets 16 and 18 to melt together in the lay-up sandwich. When bonding thermoplastic and glass laminate in a MOP, temperatures will range from 220 degrees Fahrenheit to 600 degrees Fahrenheit. The sandwich 12 is held at the appropriate temperature and pressure for 1 to 30 minutes or until the materials are fused together to form the laminate 10.

At a block 69, the product is allowed to gradually cool while maintaining the pressure at about 160 psi until the product reaches a temperature of about 100° F. at which point the press is opened and the product (which needs some trimming) is removed from the press. The laminate 10 should be cooled gradually under pressure until the laminate reaches 100 degrees Fahrenheit. The optimal temperature, pressure and time will vary depending on material combinations and laminate thickness and can be determined by those with ordinary skill in the art. If needed, a coolant may be circulated through the platens to cool the press. This step of gradually cooling the product is important because the product is being annealed, thereby removing the internal strains resulting from the previous operations. This prevents the polymeric laminate 12 from developing cracks, warping, or excessive shrinking.

### Optional Features

During the pressing/heating operation, specialty films can also be applied to one or both of the polymeric sheets to enhance the abrasion resistance, chemical resistance, and ultraviolet resistance of the final product. These specialty films may be made of various materials including polyester, polyvinylfluoride (PVF), ethylene trifluoroethylene (ETFE), fluorinated ethylene propylene (FEP), polyvinylidenefluoride (PVDF), and chlorotrifluoroethylene (CTFE).

These specialty films can be on the top and/or bottom of the final product. Typically, these films have a higher melt point than polymethylmethacrylate and therefore require the use of a heat-activated adhesive coating, which is applied to the film prior to the pressing/heating operation. Generally, the specialty film has a thickness of 0.004 inch (0.100 mm) to 0.020 inch (0.500 mm).

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A flat non-porous unitary solid surface laminate comprising:
a first flat non-porous sheet of a polymeric material having a first planar surface, the planar surface having a texture;
a visible decorative object in contact with the planar surface; and
a second flat non-porous sheet of polymeric material having a second planar surface, the second planar surface being fused to the first planar surface such that the visible decorative object is fixed between the first and second flat non-porous planar sheets without the presence of visible voids.

2. The solid surface structure of claim 1, wherein the first sheet of polymeric material is polymethylmethacrylate.

3. The solid surface structure of claim 1, wherein the first sheet of polymeric material is polyvinyl chloride.

4. The solid surface structure of claim 1, wherein the first sheet of polymeric material is polycarbonate.

5. The solid surface structure of claim 1, wherein the first sheet of polymeric material is one of a group consisting of acrylic, polycarbonate, polyvinyl chloride, polyethylene, polypropylene, polyester, nylon and polyurethane, polystyrene, fluoropolymers, acrylonitrile-butadiene-styrene or a combination thereof.

6. The solid surface structure of claim 1, wherein the decorative object is a shard of glass.

7. The solid surface structure of claim 1, wherein the decorative object is a pebble.

8. The solid surface structure of claim 1, wherein the decorative object is gravel.

9. The solid surface structure of claim 1, wherein the decorative object is a metal fragment.

10. The solid surface structure of claim 1, wherein the decorative object is a metal mechanical part.

11. The solid surface structure of claim 1, wherein the decorative object is a sea shell.

12. A method for manufacturing a flat non-porous unitary solid surface structure comprising the steps of:
imparting a surface texturing to a first planar aspect of a first sheet of polymeric material;
arranging a decorative object in contact with the first planar surface of the first sheet of polymeric material;
placing a second planar aspect of a second flat non-porous unitary sheet of a polymeric material in contact with the decorative object in opposing relationship to the first planar aspect, whereby a lay-up sandwich is formed including the first flat sheet of polymeric material, the decorative object, and the second flat sheet of polymeric material;
applying a predetermined amount of heat and pressure to the lay-up sandwich;
venting outgasses from the lay-up sandwich;
applying the predetermined amount of heat and pressure to the lay-up sandwich for a predetermined period of time whereby said first and second polymeric material sheets fuse together in the lay-up sandwich to provide a unitary product; and,
annealing the product by allowing the product to cool while maintaining the pressure at a predetermined level until the product reaches a predetermined temperature at which point the press is opened and the product is removed from the press.

13. The method of claim 12, wherein the decorative object is made a dry material.

14. The method of claim 12, wherein the decorative object is made a dry material selected from the group consisting of textile fabric, paper, plastic film, plastic sheet, metallic wire, rod, rod, mesh, bar, wood veneer, dried natural materials, tree bark, plant leaves, petals, and twigs.

15. The method of claim 12, wherein the decorative object is made a dry material selected from the group consisting of metal fragments, glass shards, preformed metal, preformed glass, sand, gravel, pebble, sea shells, marbles, and ceramic.

16. The method of claim 12, wherein the first sheet of polymeric material is polymethylmethacrylate.

17. The method of claim 12, wherein the first sheet of polymeric material is polyvinyl chloride.

18. The method of claim 12, wherein the first sheet of polymeric material is polycarbonate.

19. The method of claim 12, wherein the first sheet of polymeric material is one of a group consisting of acrylic, polycarbonate, polyvinyl chloride, polyethylene, polypropylene, polyester, nylon and polyurethane, polystyrene, fluoropolymers, acrylonitrile-butadiene-styrene or a combination thereof.

20. A countertop comprised of the flat non-porous unitary solid surface structure of claim 1.

21. A sink comprised of the flat non-porous unitary solid surface structure of claim 1.

22. A lavatory comprised of the flat non-porous unitary solid surface structure of claim 1.

23. A desktop comprised of the flat non-porous unitary solid surface structure of claim 1.

24. A table top comprised of the flat non-porous unitary solid surface structure of claim 1.

25. A chair comprised of the flat non-porous unitary solid surface structure of claim 1.

26. A windowsill comprised of the flat non-porous unitary solid surface structure of claim 1.
